(19) United States
(12) Patent Application Publication
(10) Pub. No.: US 2020/0171804 A1
(43) Pub. Date: Jun. 4, 2020

(54) FRUIT AND VEGETABLE PRESERVATION FILM AND PREPARATION METHOD THEREOF

(71) Applicant: NAN YA PLASTICS CORPORATION, TAIPEI (TW)

(72) Inventors: TE-CHAO LIAO, TAIPEI (TW); CHUN-CHE TSAO, TAIPEI (TW); Chen-Ho Lai, TAIPEI (TW); CHING-YAO YUAN, TAIPEI (TW)

(21) Appl. No.: 16/670,463

(22) Filed: Oct. 31, 2019

(30) Foreign Application Priority Data
Dec. 4, 2018 (TW) 107143495

(51) Int. Cl. B32B 27/08; B32B 27/32; B32B 27/20; B65D 65/40

(52) U.S. Cl. CPC B32B 27/08; B32B 27/32; B32B 27/20; B65D 65/40; B32B 2439/70; B32B 2439/06; B32B 2250/03; B32B 2250/242; B32B 2553/00; B32B 2264/102

(57) ABSTRACT

A preparation method of a fruit and vegetable preservation film is used for preparing a three-layer co-extrusion film having a thickness ranging from 0.02 mm to 2.0 mm. A preservation master-batch composed of 5-20% of an inorganic nano-powder and 80-95% of a resin material is uniformly distributed in one layer of the co-extrusion film.

### CROSS-REFERENCE TO RELATED PATENT APPLICATION

This application claims the benefit of priority to Taiwan Patent Application No. 107143495, filed on Dec. 4, 2018. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a polypropylene composition, and in particular, to a polypropylene composition for fruit and vegetable preservation and a preparation method thereof, which can prolong the freshness of fruits and vegetables.

### BACKGROUND OF THE DISCLOSURE

Vegetables and fruits are indispensable foods for human beings. Vegetables and fruits are rich in dietary fiber, vitamins and minerals, have the health benefits of increasing satiety, promoting gastrointestinal motility, and lowering blood cholesterol, and are also the nutrients required for maintaining health. Many studies have pointed out that one of the causes of chronic diseases is insufficient intake of fruits and vegetables. The World Health Organization and many advanced countries have listed the intake of fruits and vegetables as an important advocacy, and encourage the public to eat more fruits and vegetables, which shows the importance of fruits and vegetables to human health and the trend of more attention being directed to nutritional characteristics of fruits and vegetables.

The main difference between fruits and vegetables and other foods is that fruits and vegetables are still living organisms, and are easily affected by temperature, humidity, microorganisms and the like to induce corruption. Therefore, the preservation of fruits and vegetables is quite important. At present, the common method of vegetable and fruit preservation technology is refrigerated storage preservation and controlled atmosphere storage preservation. Refrigerated storage preservation is simple and easy to implement, but there is no complete method for improving issues of short on-shelf period of fruits and vegetables in a market and corruption in the process of logistics and transportation. Controlled atmosphere preservation bags used in controlled atmosphere storage preservation have the following problems: first, when fruits and vegetables are preserved in the controlled atmosphere preservation bags, aging hormones such as ethylene are released during the metabolism of fruits and vegetables. These aging hormones are accumulated in the preservation bags and cannot be dissipated, and will accelerate the decay of fruits and vegetables and adversely affect storage and preservation. Secondly, the resin material of the controlled atmosphere preservation bag has no antibacterial and mildew-proof effect, and bacterial growth and mildew during storage cause the fruits and vegetables to decay. Thirdly, due to the limitation of the permeability of the resin material, for the fruits and vegetables with different respiration effects, it is necessary to prepare the controlled atmosphere preservation bags of different resin materials to adjust the gas in the bags to a suitable composition according to different densities, so that these bags cannot be universally applied. Finally, at present, some multi-layer food packaging materials can be applied to the preservation of fruits and vegetables, but the production process is complicated and expensive.

### SUMMARY OF THE DISCLOSURE

In order to overcome the issues of the conventional preservation material such as poor gas permeability, no antibacterial and mildew-proof effect, easy vegetable and fruit corruption, complicated production process and high cost, the present disclosure provides a polypropylene composition for fruit and vegetable preservation and a preparation method thereof. The preparation method has the advantages of simple production process and low cost, and can effectively prolong the freshness lifetime of fruits and vegetables and increase the shelf life of fruits and vegetables. The preparation method reduces food waste during packaging, logistics transportation, and sale in the shelf life of fruits and vegetables after harvesting, and is applicable to preservation applications at all stages of the fruit and vegetable supply chain, including blue preservation bags for fruits and vegetables used after B2B harvesting, preservation bags for fruits and vegetables used in B2C shelf display, and preservation film for fruits and vegetables for general household use and other preservation products, thereby reducing waste generation, saving energy and reducing carbon emission to protect the earth.

The polypropylene composition of the present disclosure includes a composite inorganic nano-powder and a resin material as primary components and an antifogging agent as a secondary component, and adopts a biaxial stretching process or a general bag making technique. The process includes the following steps:

a) uniformly mixing 5-20 wt % of a composite inorganic nano-powder and 80-95 wt % of a resin as raw materials using a high-speed disperser to form a mixture;

b) preparing the mixture of step a) into a preservation master-batch using a twin-screw extruder; and

c) uniformly mixing 5-10 wt % of the preservation master-batch and 100 wt % of one or more of polypropylene resin materials, and subjecting the mixture to extrusion mixing, cooling molding, longitudinal stretching, horizontal stretching, finished product cutting and other processes in a three-layer co-extrusion film forming mode to prepare a fruit and vegetable preservation film, or further preparing the preservation film into a fruit and vegetable preservation bag by means of a bag making device, wherein the prepared packaging material or bag body has an optimal long-term fruit and vegetable preservation effect.

The production process of the present disclosure is simple, and can be combined with the existing film and bag body equipment and technology, and has considerable industrial production value.

The fruit and vegetable preservation film of the present disclosure has the following beneficial effects.

(1) The fruit and vegetable preservation film can absorb plant aging hormones, slow down the withering of fruits and vegetables, and maintain freshness.

(2) The fruit and vegetable preservation film has the mildew-proof and antibacterial effect, can effectively maintain the cleanliness of a storage environment of fruits and vegetables, reduce the probability of bacterial growth and mildew, and maintain a verdant and nutritious state of the fruits and vegetables.

(3) The fruit and vegetable preservation film can regulate the gas composition in the preservation bag, inhibit the respiration of fruits and vegetables, and delay the aging.

(4) The functional film has a moisture retention effect, which can prevent the fruits and vegetables from losing water and keep them dry and crisp.

(5) The fruit and vegetable preservation film can be combined with the existing film and bag body equipment and technology, and has a simple production process and considerable industrial production value.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The present disclosure will become more fully understood from the following detailed description and accompanying drawings.

FIG. 1 is an enlarged cross-sectional view showing a fruit and vegetable preservation film of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

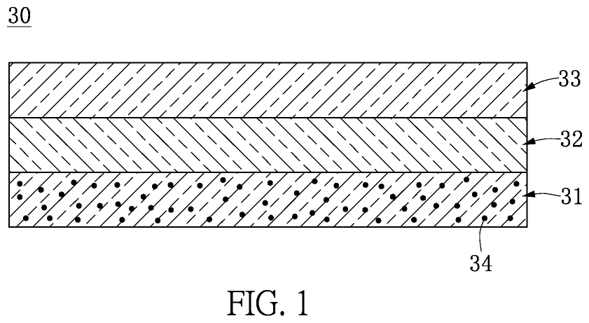

As shown in FIG. 1, a fruit and vegetable preservation film 30 of the present disclosure has a thickness ranging from 0.02 to 2.0 mm, is a three-layer co-extrusion film product in a bag shape or a film shape, and is a transparent polypropylene film having transparency, anti-fog and preservation properties.

The fruit and vegetable preservation film 30 of the present disclosure is composed of a lower co-extrusion film 31, a middle co-extrusion film 32, and an upper co-extrusion film 33, and a preservation master-batch 34 is uniformly distributed in the structure of one layer of the co-extrusion film, and preferably in the structure of the lower co-extrusion film 31.

The fruit and vegetable preservation film 30 of the present disclosure is prepared by a preparation method including the following steps:

(1) providing a composition formulation of the middle co-extrusion film 32: a polypropylene resin 100 PHR and an antifogging agent 0.1-10 PHR;

(2) providing a composition formulation of the upper co-extrusion film 33: a polypropylene resin 100 PHR and an inorganic oxide powder 0.1-10 PHR;

(3) providing a composition formulation of the lower co-extrusion film 31: a polypropylene resin 100 PHR, an inorganic oxide powder 0.1-10 PHR, and a preservation master-batch 0.2-20 PHR;

(4) introducing the respective formulations of each layer of co-extrusion film into a three-layer co-extruder for uniformly melting and mixing; and

(5) controlling the material temperature at 220-260° C., cooling and molding the fully reacted and melted mixture by means of a T die into a polypropylene composition sheet having a thickness ranging from 0.04 mm to 4.0 mm; performing longitudinal stretching and horizontal stretching in a specialized stretcher after molding, reaching a draw ratio of 4-10 times; and rolling up to prepare a three-layer co-extrusion fruit and vegetable preservation film 30 having a thickness ranging from 0.02 mm to 2.0 mm.

The polypropylene resin used in each layer of the co-extrusion film formulation may be one of or a combination of polypropylene polymers or copolymers prepared by bulk polymerization, suspension polymerization, solution polymerization, or emulsion polymerization.

In the formulation of the middle co-extrusion film 32, the antifogging agent used may be selected from one or more of glycerin fatty acid esters, sorbitan fatty acid esters, and ethylene oxide adducts of glycerin monoesters or sorbitan monoesters.

In the formulation of the lower co-extrusion film 31, the preservation master-batch 34 used has nanoparticles with the particle size ranging from 50 nm to 200 nm, and may be selected from one or more of nano-composite oxides, depending on the requirements of different physical properties such as transparency and haze.

In the formulations of the upper co-extrusion film 33 and the lower co-extrusion film 31, the inorganic oxide powder used may be selected from one or more composite inorganic oxide powders such as silicon oxide or calcium oxide.

In the formulation of each layer of the co-extrusion film, an auxiliary agent may be added, including one or more of a modifier, a dispersant, or a coupling agent. The purpose of adding the auxiliary agent is to promote the uniform dispersion of the preservation master-batch 34 in the structure of the polypropylene composition 31.

The coupling agent may be selected from one or more of an organosilane compound coupling agent, an organic zirconium aluminum compound coupling agent, or an organic titanium aluminum compound to facilitate processing and prevent precipitation.

The present disclosure will be described below in more detail with examples. Although the present disclosure is described in detail with examples, the technique and scope of the present disclosure are not limited thereto. In addition, evaluation of the physical properties of the present disclosure is carried out by the following methods.

(1) Weight and Weight Loss Rate Over Time after Packaging of Fruits and Vegetables:

The weight and the weight loss rate over time after packaging of fruits and vegetables in the following examples are tested using METTLER TOLEDO ELECTRIC BALANCE, model GG4002-S. The lower the weight loss rate over time after packaging of fruits and vegetables is, the better the moisture retention effect of the polypropylene composition film for long-term fruit and vegetable preservation is.

(2) Leaf Color Difference in Lab:

The Konica Minolta machine, model CR-400, is used to test color difference over time after packaging of fruits and vegetables in the examples. The smaller the color difference over time after packaging of fruits and vegetables is, the lower the degree of yellowing of the fruits and vegetables is, the better the preservation effect of the polypropylene composition film for long-term fruit and vegetable preservation is.

(3) CO₂/O₂ Gas Concentration:

The WITT machine, model OXYBABY® M+, is used to test the concentrations of CO₂ and O₂ in the bag over time after packaging of fruits and vegetables in the examples. The higher the concentration of CO₂ in the bag over time after packaging of fruits and vegetables is, and the lower the O₂ concentration is, the better the effect of inhibiting the respiration of fruits and vegetables by the polypropylene composition film for long-term fruit and vegetable preservation is, which helps to slow down the metabolism and prolong the shelf life.

(4) Crispness:

A texture analyzer, model XT plus, produced by Stable Micro Systems, is used to measure the applied force from contact to 80% deformation of the petiole with the pressing speed being 2 mm per second, which simulates the crispness of fruits and vegetables. The higher the crispness over time after packaging of fruits and vegetables is, the better the moisture retention effect of the polypropylene composition film for long-term fruit and vegetable preservation, which helps to slow down the aging and maintain freshness.

(5) Appearance:

The Nikon Digital Camera model D5300, is used to record the change in appearance over time after packaging of fruits and vegetables in the following examples. The slighter the withering and yellowing over time after packaging of fruits and vegetables is, the better the moisture retention and preservation and antibacterial effect of the polypropylene composition film for long-term fruit and vegetable preservation is.

(6) Chlorophyll:

The change in chlorophyll content over time after packaging of fruits and vegetables of the following examples is tested using a chlorophyll meter, model SPAD-502 plus, produced by Konica Minolta. The lower the decrease degree of the chlorophyll content over time after packaging of fruits and vegetables is, the better the nutritional preservation state of the polypropylene composition film for long-term fruit and vegetable preservation is.

### Example 1

A method for preparing the three-layer co-extrusion fruit and vegetable preservation film 30 with a thickness of 0.02 mm is as follows.

Following the specific formulation in Table 2, a. a middle co-extrusion film; a polypropylene resin and an antifogging agent; b. an upper co-extrusion film; a polypropylene resin and an inorganic oxide powder; c. a lower co-extrusion film; a polypropylene resin, an inorganic oxide powder and a preservation master-batch are uniformly mixed by a mixer, respectively, and then introduced into a three-layer co-extrusion extruder for uniformly melting and mixing.

The material temperature is controlled at 220-260° C., and the fully reacted and melted mixture is cooled and molded by means of a T die into a polypropylene composition sheet. After molding, longitudinal stretching and horizontal stretching are performed in a specialized stretcher. After reaching a draw ratio of 4-10 times, rolling up is performed to prepare the polypropylene composition for long-term fruit and vegetable preservation having a thickness of 0.02 mm.

The test results are shown in Table 1, and indicate that a test subject preserved by the obtained polypropylene composition 30 for long-term fruit and vegetable preservation has good appearance, crispness, chlorophyll content, and low weight loss rate and CO₂/O₂ gas concentration.

### Example 2

Except for the addition ratio of 3.44 PHR of the preservation master-batch different from that of Example 1, the remaining raw material formulations and preparation method of the obtained fruit and vegetable preservation film 30 are the same as those of Example 1.

The test results are shown in Table 1, and indicate that the test subject preserved by the obtained fruit and vegetable preservation film 30 has good appearance, crispness, chlorophyll content, and low weight loss rate and CO₂/O₂ gas concentration, and the preservation effect is superior to that of Example 1.

### Example 3

Except for the addition ratio of 7.77 PHR of the preservation master-batch different from that of Example 1, the remaining raw material formulations and preparation method of the obtained fruit and vegetable preservation film 30 are the same as those of Example 1.

The test results are shown in Table 1, and indicate that the test subject preserved by the obtained fruit and vegetable preservation film 30 has excellent appearance, crispness, chlorophyll content, and low weight loss rate and CO₂/O₂ gas concentration, and the preservation effect is further superior to that of Example 2.

### Comparative Example 1

Except for the source of the preservation master-batch different from that of Example 3 and the commercially available ethylene-free master-batch used, the remaining raw material formulations and preparation method of the obtained fruit and vegetable preservation film 30 are the same as in those of Example 3.

The test results are shown in Table 1, and indicate that the appearance, crispness, chlorophyll content, weight loss rate and CO₂/O₂ gas concentration of the test subject preserved by the obtained fruit and vegetable preservation film 30 are significantly inferior to those in Example 3, and the preservation effect is inferior to that of Example 3.

TABLE 1
Formulation and preservation effect of polypropylene
compositions for long-term fruit and vegetable preservation

| | | | | | Comparative |
|---|---|---|---|---|---|
| | | Example 1 | Example 2 | Example 3 | Example 1 |
| Upper co- | Polypropylene | 100 | 100 | 100 | 100 |
| extrusion | resin | | | | |
| film | Inorganic | 5.67 | 5.67 | 5.67 | 5.67 |
| | oxide | | | | |
| Middle co- | Polypropylene | 100 | 100 | 100 | 100 |
| extrusion | resin | | | | |
| film | Antifogging | 3.83 | 3.83 | 3.83 | 3.83 |
| | agent | | | | |
| Lower co- | Polypropylene | 100 | 100 | 100 | 100 |
| extrusion | resin | | | | |
| film | Preservation | 0 | 3.44 | 7.77 | — |
| | master-batch | | | | |
| | Commercially | — | — | — | 7.77 |
| | available | | | | |
| | ethylene-free | | | | |
| | master-batch | | | | |
| | Inorganic | 5.65 | 5.65 | 5.65 | |
| | oxide | | | | |
| Spoon cabbage | Appearance | Moderate | Slight | No | Moderate |
| (refrigerated | | yellowing | yellowing | yellowing | yellowing |
| at 5° C. | Crispness (N) | 2.5 | 2.7 | 3.2 | 2.4 |
| for 14 days) | Chlorophyll | 28.2 | 32.1 | 37.1 | 28.7 |
| | content | | | | |
| | (SPAD) | | | | |
| | Weight loss | 3.17 | 1.69 | 0.79 | 3.42 |
| | rate (%) | | | | |
| | CO₂/O₂ | 0.3/20.85 | 2.2/18.76 | 3.3/16.35 | 0.4/20.78 |
| | concentration | | | | |
| | (%) | | | | |

Dosage unit: PHR (per hundred parts by weight of resin)

The actual test results of the fruit and vegetable preservation bag of the present disclosure are as follows:

TABLE 2
Comparison of preservation test results

| | | Room temperature 23° C. | | Refrigerated in refrigerator at 5° C. | |
|---|---|---|---|---|---|
| | | | Preservation | | Preservation |
| | | General | bag of the | General | bag of the |
| Environment | | antifogging | present | antifogging | present |
| Sample | | bag | disclosure | bag | disclosure |
| Days of | Spoon | 2 days | 6 days | 6 days | 14 days |
| preservation | cabbage | | | | |
| (no yellowing | Komatsuna | 2 days | 6 days | 6 days | 14 days |
| and | Pakchoi | 2 days | 6 days | 5 days | 13 days |
| dehydration) | cabbage | | | | |
| | Cut apple | 2 days | 5 days | 4 days | 10 days |

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A fruit and vegetable preservation film, the fruit and vegetable preservation film being a three-layer co-extrusion film having a thickness ranging from 0.02 mm to 2.0 mm, a preservation master-batch being uniformly distributed in one layer of the co-extrusion film, characterized in that respective formulations of each layer of the co-extrusion film are:
(a) a middle co-extrusion film, including: a polypropylene resin 100 PHR; and
an antifogging agent 0.1-10 PHR;
(b) an upper co-extrusion film, including: a polypropylene resin 100 PHR; and
an inorganic oxide powder 0.1-10 PHR; and
(c) a lower co-extrusion film, including: a polypropylene resin 100 PHR; and
an inorganic oxide powder 0.1-10 PHR; and
a preservation master-batch 0.2-20 PHR, wherein the preservation master-batch is composed of 5-20 wt % of an inorganic nano-powder and 80-95 wt % of a resin material.

2. The fruit and vegetable preservation film according to claim 1, wherein the fruit and vegetable preservation film is in the shape of a bag.

3. The fruit and vegetable preservation film according to claim 1, wherein the fruit and vegetable preservation film is in the shape of a film.

4. A method of preparing the fruit and vegetable preservation film as claimed in claim 1, comprising:
(1) uniformly mixing 5-20 wt % of a composite inorganic nano-powder and 80-95 wt % of a resin as raw materials to form a mixture, and then using a twin-screw extruder to prepare the mixture into a preservation master-batch;
(2) introducing the respective formulations of each layer of the co-extrusion film into a three-layer co-extruder for uniformly melting and mixing;
(3) controlling the material temperature at 220-260° C., and cooling and molding the fully reacted and melted mixture by means of a T die into a polypropylene composition sheet having a thickness ranging from 0.04 mm to 4.0 mm, and introducing into step (4) after the molding; and
(4) performing longitudinal stretching and horizontal stretching in a stretcher, reaching a draw ratio of 4-10 times, to prepare a three-layer co-extrusion fruit and vegetable preservation film having a thickness ranging from 0.02 mm to 2.0 mm.

5. The method according to claim 4, wherein the preservation master-batch includes 2-5 wt % of a dispersant.

6. The method according to claim 4, wherein the composite inorganic nano-powder of the preservation master-batch has a particle size ranging from 50 nm to 200 nm.

7. The method according to claim 4, wherein the polypropylene resin used is selected from one or more of polypropylene polymers or copolymers obtained by bulk polymerization, suspension polymerization, solution polymerization, or emulsion polymerization.

8. The method according to claim 4, wherein the antifogging agent is selected from one or more of glycerin fatty acid esters, sorbitan fatty acid esters, and ethylene oxide adducts of glycerin monoesters and sorbitan monoesters.

9. The method according to claim 4, wherein the inorganic oxide powder is selected from one or more of silicon oxides and calcium oxides.

10. The method according to claim 5, wherein the dispersant is selected from one or more of a polymer-type copolymer dispersant, a silicon-containing dispersant, and a fluorine-containing dispersant.
